(19) United States
(12) Patent Application Publication
(10) Pub. No.: US 2022/0036425 A1
(43) Pub. Date: Feb. 3, 2022

(54) SYSTEM FOR PROVIDING AND SOURCING LOCAL FOOD PRODUCTS

(71) Applicants: Kristine A. Fetters, Ozark, MO (US); Christopher Fetters, Ozark, MO (US)

(72) Inventors: Kristine A. Fetters, Ozark, MO (US); Christopher Fetters, Ozark, MO (US)

(21) Appl. No.: 17/493,718

(22) Filed: Oct. 4, 2021

Related U.S. Application Data
(60) Provisional application No. 63/060,084, filed on Aug. 2, 2020.

(51) Int. Cl. G06Q 30/06; G06F 16/9538

(52) U.S. Cl. CPC G06Q 30/0627; G06F 16/9538; G06Q 30/0635; G06Q 30/0641; G06Q 30/0605; G06Q 30/0639

(57) ABSTRACT

A system for providing and sourcing local groceries is disclosed, comprising a provider database storing provider information, a product database storing product information, and a consumer database storing consumer information. A user interface module displays the provider information, the product information, and the consumer information on the display of a computing device. A search engine permits the consumer to input search parameters, wherein the user interface module displays a plurality of search results corresponding to the search parameters.

### CROSS-REFERENCE TO RELATED APPLICATIONS

The present application claims priority to U.S. Provisional Patent Application No. 63/060,084 filed Aug. 2, 2020, entitled “SYSTEM FOR PROVIDING AND SOURCING LOCAL FOOD PRODUCTS,” which is hereby incorporated by reference in its entirety.

### TECHNICAL FIELD

The embodiments generally relate to computerized systems for sourcing groceries and, more particularly, to computerized systems for connecting local farmers with consumers to allow consumers to source locally grown food items.

### BACKGROUND

The food industry is a complex, global collective of businesses that supply food to the world's population. Very few individuals, such as subsistence farmers and hunter-gatherers, escape the reach and influence of the current-day food industry. The food industry includes agriculture, manufacturing, food processing, marketing, wholesale and distribution, foodservice, and grocery industries, among others. Each industry forms a step in the process of growing, selling, distributing, and preparing food before it is eventually consumed.

In recent years, movements such as farm-to-table have promoted the importance of supporting local farmers, which in turn can service the local population. Benefits include supporting the local economy as well as benefiting the environment by reducing the carbon footprint of food products and the operations surrounding them. Often, local farmers frequent farmers markets or distribute to small local grocery stores in order to market their goods and connect with consumers. While effective, these outlets only allow a small subset of potential consumers to actually purchase goods and interact with the farmer.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The embodiments provided herein relate to a system for providing and sourcing local groceries, comprising a provider database storing provider information, a product database storing product information, and a consumer database storing consumer information. A user interface module displays the provider information, the product information, and the consumer information on the display of a computing device. A search engine permits the consumer to input search parameters, wherein the user interface module displays a plurality of search results corresponding to the search parameters.

The system provides a means for providing and sourcing groceries, while connecting local farmers with consumers. The system allows local farmers to create a user profile and offer products for sale, including providing options for pick-up and delivery. Consumers may create a profile to communicate with local farmers, discover their product and service offerings, and schedule the pick-up and delivery of products.

In one aspect, the search results include a plurality of providers.

In one aspect, a payment processor processes a payment between the consumer and the provider.

In one aspect, the user inputs payment information via a payment interface.

In one aspect, the plurality of products includes at least one of the following: at least one meat product, at least one seafood product, and at least one produce product.

In one aspect, the search parameters permit the user to input a search location.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of the network infrastructure, according to some embodiments;

FIG. 2 illustrates a block diagram of a computing system and an application program, according to some embodiments;

FIG. 3 illustrates a block diagram of the application program, according to some embodiments;

FIG. 4 illustrates a screenshot of the location interface, according to some embodiments;

FIG. 5 illustrates a screenshot of the provider selection interface, according to some embodiments;

FIG. 6 illustrates a screenshot of the product selection interface, according to some embodiments;

FIG. 7 illustrates a screenshot of the payment interface, according to some embodiments; and

FIG. 8 illustrates a flowchart of a method for sourcing and providing local products, according to some embodiments.

### DETAILED DESCRIPTION

The specific details of the single embodiment or variety of embodiments described herein are to the described system and methods of use. Any specific details of the embodiments are used for demonstration purposes only, and no unnecessary limitations or inferences are to be understood thereon.

Before describing in detail exemplary embodiments, it is noted that the embodiments reside primarily in combinations of components and procedures related to the system. Accordingly, the system components have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this disclosure, the various embodiments may be a system, method, and/or computer program product at any possible technical detail level of integration. A computer program product can include, among other things, a computer-readable storage medium having computer-readable program instructions thereon for causing a processor to carry out aspects of the present disclosure.

In general, the embodiments provided herein relate to a system for providing and sourcing groceries, while connecting local farmers with consumers. The system allows local farmers to create a user profile and offer products for sale, including providing options for pick-up and delivery. Consumers (i.e., users) may create a profile to communicate with local farmers, discover their product and service offerings, and schedule pick-up and deliveries of products.

As used herein, the term “provider” relates to farmers or similar providers of foodstuff. For example, the provider may provide meat, seafood, produce, dairy, eggs, or other raw or prepared foods.

As used herein, the term “product” refers to any type of foodstuff provided by the provider, including, for example, meat, seafood, produce, dairy, eggs, or other raw or prepared foods. The product may be ordered and picked up by the consumer or scheduled for delivery by the provider or a third-party individual or organization.

As used herein, the term “consumer” or “user” may relate to any individual or organization purchasing a product from or interacting with the provider. The consumer may be an individual or a member of an organization, such as a restaurant, requesting locally-sourced products. It is to be understood that the terms “consumer” and “user” may be used interchangeably.

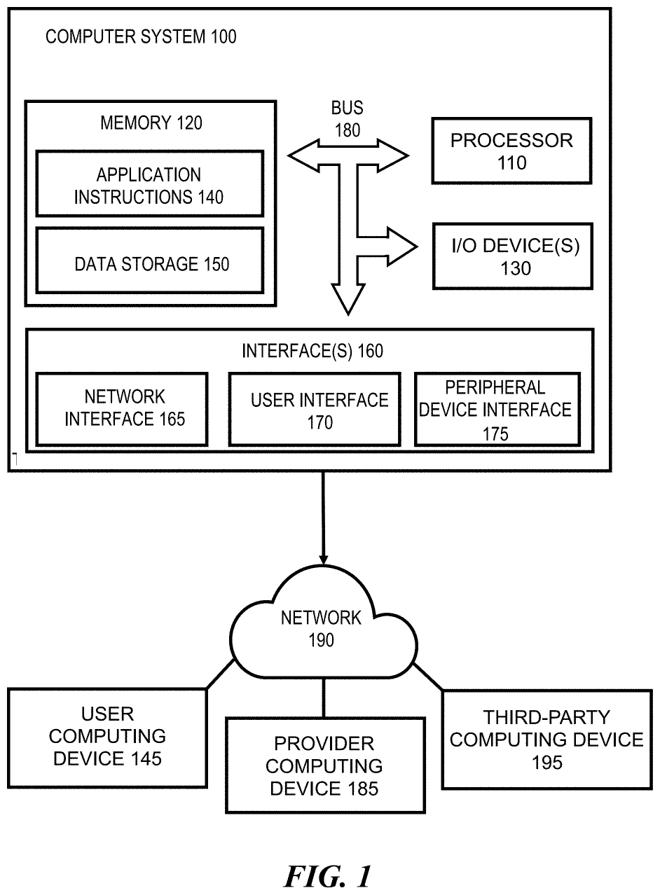

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, microcomputers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., C, C++, C#, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and nonvolatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145, an administrator computing device 185 and a third-party computing device 195 each in communication via the network 190. The user computing device 145 may be utilized by a user to search for products, select products to view information, purchase products, view provider information, interact with providers, and otherwise interact with the system functionalities. The provider computing device 185 is utilized by providers to submit products to be sold using the system, to interact with users, and to otherwise interact with the functionalities of the system. The third-party computing device 195 may be utilized by third parties to receive communications from the user computing device, transmit communications to the user via the network, and otherwise interact with the various functionalities of the system. In one example, third-parties 195 may use the system for to display advertisements to consumers and providers alike.

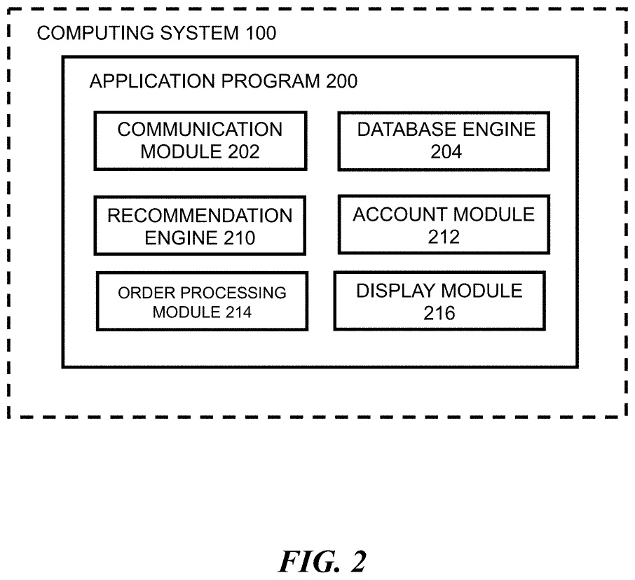

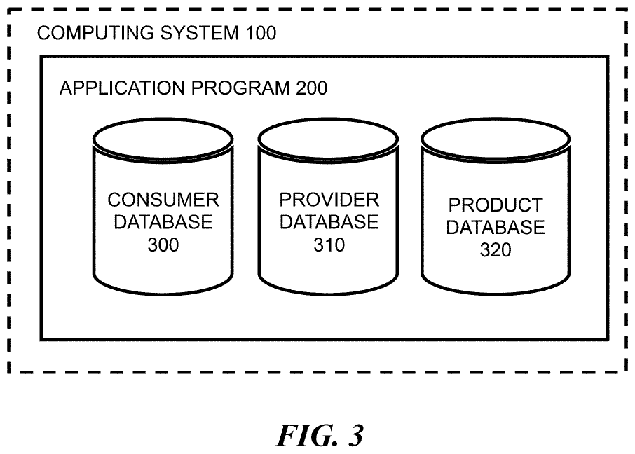

FIGS. 2 and 3 illustrate an example computer architecture for the application program 200 operated via the computing system 100. The computer system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200, and FIG. 3 is a block diagram showing the various databases utilized by the various modules.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a recommendation engine 210, an account module 212, an order processing module 214, and a display module 216.

In some embodiments, the communication module 202 is configured for receiving, processing, and transmitting a user command and/or one or more data streams. In such embodiments, the communication module 202 performs communication functions between various devices, including the user computing device 145, the consumer computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195.

In some embodiments, the communication module 202 allows consumers to communicate with providers of a product. In such, the consumer may ask questions, receive a location of the product, and otherwise transmit information. Similarly, the provider may communicate with consumers.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the database engine 204 is in operable communication with aa product database configured to store item details including product nutritional information, product location, product source, etc.

In some embodiments, the recommendation engine 210 is in operable communication with the application system 200 to provide recommendations for products and/or providers based on user preferences, user search history, previously purchased products, user location, etc. For example, the recommendation engine 210 may recommend products within a 20-mile radius of the user, wherein the products recommended are also references with the user's purchase history.

In some embodiments, the account module 212 facilitates the creation of a consumer and/or provider account for the application system. The account module 212 may allow the user and/or provider to upload personal information, store preferences (e.g., preferred products, location, etc.). Alternatively, the account module 212 may be utilized by a third-party user, such as by a provider of goods to upload products which may be auxiliary to the food products (e.g., cooking utensils, seasonings, appliances, recipes, etc.).

In some embodiments, the order processing module 214 is configured to permit the user to purchase a product and for the provider to receive the processed order. The order processing module 214 may receive orders and transmit a notification to the provider to process the order (e.g., begin packaging and/or shipping the ordered products).

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored. The display module 216 may be in communication with the recommendation engine 210 to display recommended products based on the user inputs into the database engine 204.

FIG. 3 illustrates the computing system 100 in operable communication with the application program 200 having a plurality of databases in communication thereto. A consumer database 300 is operable to store consumer (user) information such as user preferences, user profile information, historical usage data, historical content, communications information, etc. The consumer database 300 may also store previously purchased products and/or providers with which the user has interacted with. This may be advantageous in allowing for item comparisons. The provider database 310 stores provider information including products which the provider provides, the provider's location(s), etc. The product database 320 stores product information including product type (e.g., meat, dairy, fruit, vegetable, etc.), inventory of the product, product source information, nutritional information, etc.

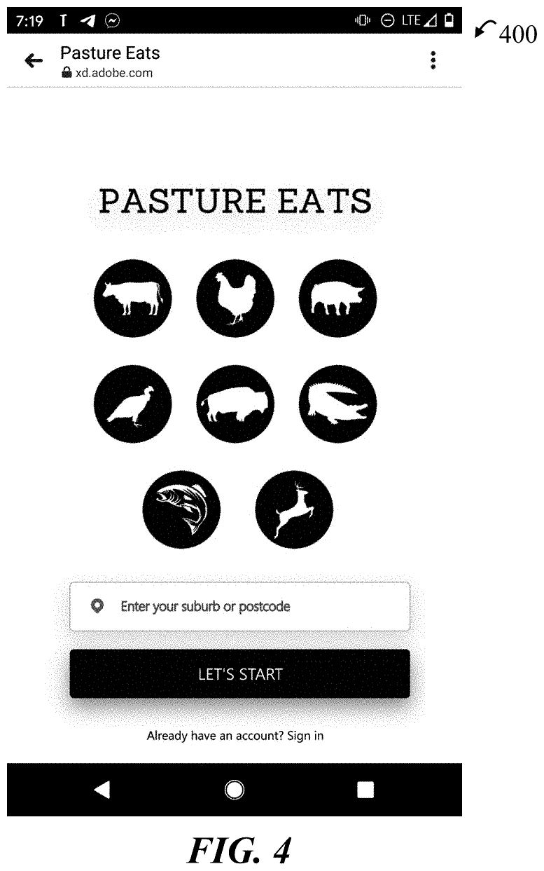

FIG. 4 illustrates a screenshot of the location interface 400 wherein the user inputs a location in the location search field provided thereon. For example, the user may select their local zip code, neighborhood, city, region, or the like to search for nearby providers. The user may be prompted to input search parameters such as a search range (e.g., within 50 miles of a current location, zip code, etc.), product type (e.g., meat, seafood, produce, eggs, dairy, etc.), farm type (e.g., organic, free-range, etc.) and the like.

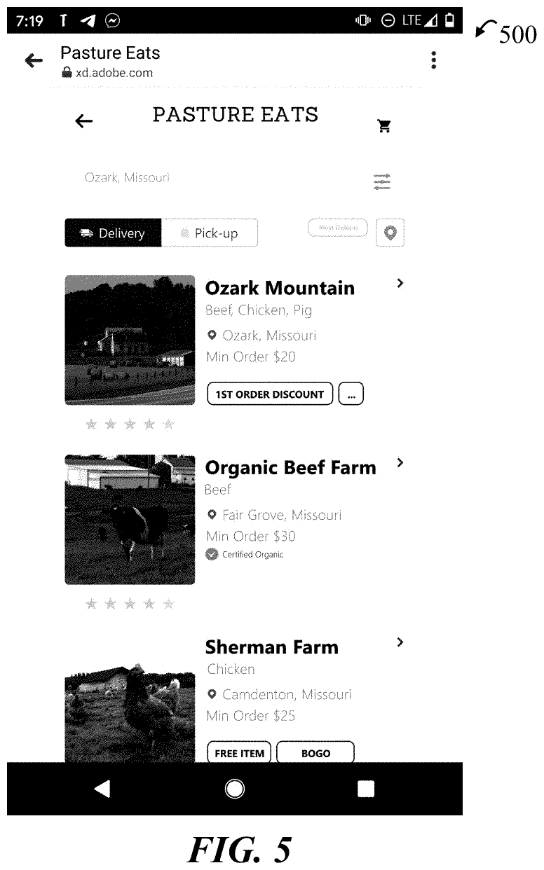

FIG. 5 illustrates a screenshot of the provider selection interface 500 wherein a plurality of providers are displayed on the display of the computing device. Each provider may include a location, summary, product summary, contact information, discounts and promotions, delivery options, and additional details related to the provider (e.g., organic options, free-range, grass-fed, etc.). The provider interface 500 is displayed following a search performed by the user for providers, which are selected for based on search parameters input by the user. The user may also select delivery options, including the option to pick-up an order at the provider location or the option to have a plurality of products delivered to the consumers location.

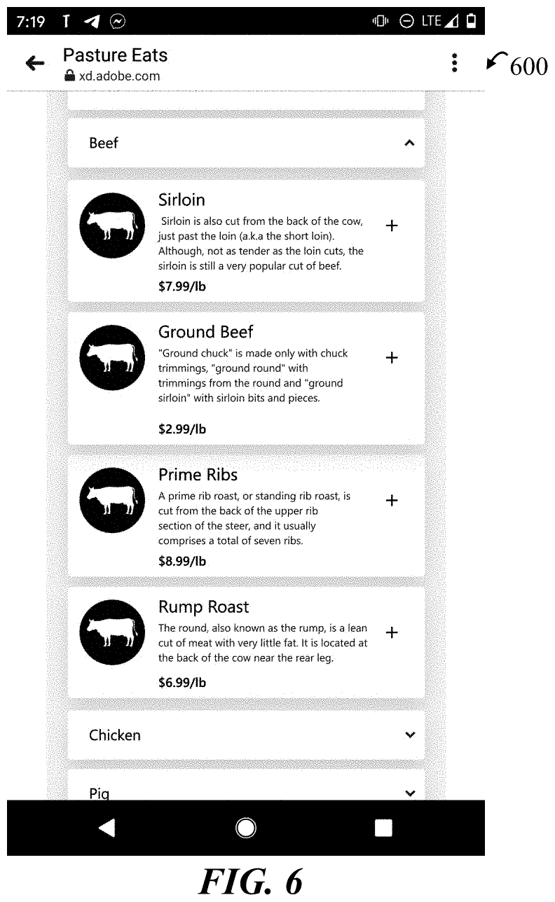

FIG. 6 illustrates a screenshot of the product selection interface 600 wherein a plurality of products provided by the provider are displayed. The products may include product details such as product type (e.g., meat, seafood, eggs, dairy, produce, etc.), product preparation, price, etc. The user may select the product to view additional information or to add the product to a list of products they wish to purchase using the purchase interface 600 and payment processing systems.

In some embodiments, the user may be provided with drop-down menus for product types, such as drop-down menus for beef, chicken, pork, etc. Selecting one or more drop down lists will provide the user with a listing of related products.

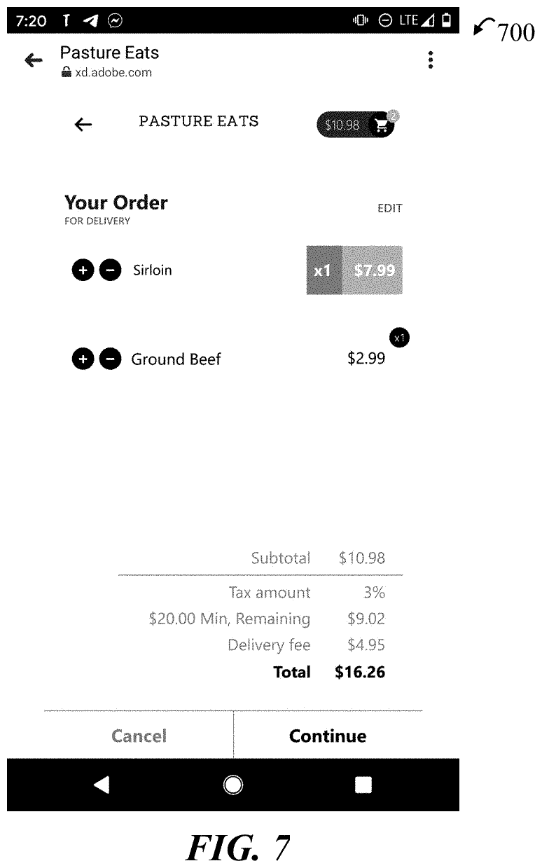

FIG. 7 illustrates a screenshot of the payment interface 700 wherein the user inputs payment information to allow a payment processor to process payment for a plurality of products selected by the user. The payment processing interface 700 includes a listing of the products the user has selected, a payment total, fees and taxes, as well as an input for payment and shipping information.

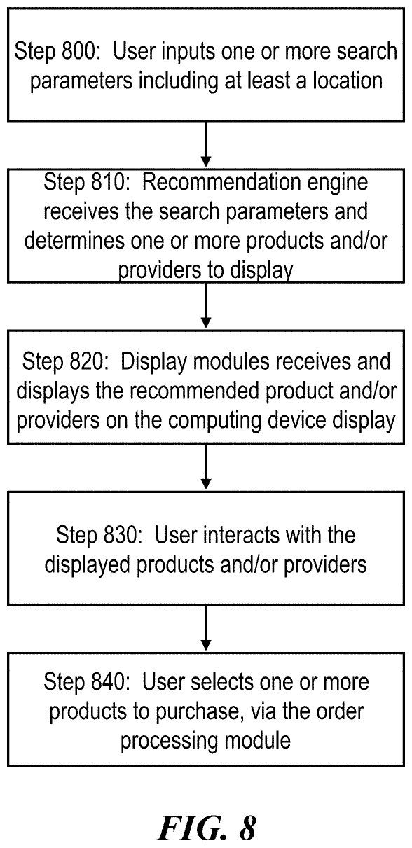

FIG. 8 illustrates a flowchart of the system for sourcing and providing local food products. In step 800, the user inputs one or more search parameters. The search parameters may include a product type, provider, location, quantity, order pick-up/receiving date, or other search parameter to search the product and/or provider database(s). The system may suggest a location which is within a predefined radius of the user's location such that local products and/or providers are favored by the recommendation engine. Further, the user may select to only view organic products, grass-fed products, fair trade products, etc. In step 810, the recommendation engine receives the search parameters and determines one or more products and/or providers to display to the user. The products and/or providers may be displayed in descending order of relevance, proximity to the user, or by price preferences. In step 820, the display module receives and displays the recommended products and/or providers to the user on the computing device display. In step 830, the user interacts with the displayed products and/or providers to view and interact with the product/provider information and/or to communicate with the provider. In step 840, the user may select one or more products to purchase. Each selected product and purchasing information associated therewith may then be transmitted to the order processing module.

In this disclosure, the various embodiments are described with reference to the flowchart illustrations and/or block diagrams of methods, apparatus (systems), and computer program products. Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for providing and sourcing local groceries, the system comprising:
a provider database storing provider information, a product database storing product information, and a consumer database storing consumer information;
a user interface to display the provider information, the product information, and the consumer information on a computing device; and
a database engine to permit the consumer to input search parameters, wherein the user interface displays a plurality of search results corresponding to the search parameters.

2. The system of claim 1, wherein the search results include a plurality of providers, wherein each of the plurality of providers are located with a predefined radius of a user's location.

3. The system of claim 2, further comprising an order processing module to process an order executed by the user.

4. The system of claim 3, wherein the user inputs payment information via a payment interface.

5. The system of claim 1, wherein the plurality of products includes at least one of the following: at least one meat product, at least one seafood product, and at least one produce product.

6. The system of claim 5, wherein the plurality of products include one or more organic products.

7. The system of claim 1, wherein the search parameters permit the user to input a search location.

8. A system for providing and sourcing local products, the system comprising:
at least one user computing device in operable connection with a network;
an application server in operable communication with the user network, the application server configured to host an application program for providing a system for providing and sourcing local products, the application program having a user interface for providing access to the application program through a consumer computing device and a provider computing device; and
a recommendation engine for receiving a plurality of search parameters input by from the consumer computing device and to determine one or more products to display, the one or more products displayed via a display module;
an order processing module for processing an order for one or more products.

9. The system of claim 8, further comprising an account module to store a plurality of consumer information or a plurality of provider information.

10. The system of claim 8, wherein a communication module permits the transmission of communications between the consumer computing device and the provider computing device.

11. The system of claim 8, wherein the search results include a plurality of providers, wherein each of the plurality of providers are located with a predefined radius of a user's location.

12. The system of claim 11, further comprising an order processing module to process an order executed by the user.

13. The system of claim 12, wherein the user inputs payment information via a payment interface.

14. The system of claim 13, wherein the plurality of products includes at least one of the following: at least one meat product, at least one seafood product, and at least one produce product.

15. The system of claim 14, wherein the plurality of products include one or more organic products.

16. The system of claim 15, wherein the plurality of search parameters permit the user to input a search location.

17. The system of claim 8, wherein the display module is operable to display the one or more providers.

18. A method for providing and sourcing local products, the method comprising the steps of:
inputting, via a user, one or more search parameters, wherein at least one of the one or more search parameters includes a location;
receiving, via a recommendation engine, the one or more search parameters;
determining, via the recommendation engine, the one or more products and one or more providers to recommend based on the one or more search parameters;
displaying, via a display module, the one or more recommended products and the one or more recommended providers.

19. The method of claim 18, further comprising the step of: selecting, via the user, at least one of the one or more products to purchase.

20. The method of claim 19, further comprising an order processing module to process the order of the one or more purchased products.
